(19) United States
(12) Patent Application Publication
(10) Pub. No.: US 2007/0234873 A1
(43) Pub. Date: Oct. 11, 2007

(54) Drum Design with Acoustic Advantages and for minimal Travel from Drum to Drum

(76) Inventor: Fred P. Lane, Mosinee, WI (US)

Correspondence Address: LANE PATENTS LLC, 100 NORTH 72ND AVE., SUITE 107, WAUSAU, WI, 54401, US

(21) Appl. No.: 11/733,887

(22) Filed: Apr. 11, 2007

Related U.S. Application Data
(63) Continuation-in-part of application No. 60/744,647, filed on Apr. 11, 2006.

(51) Int. Cl. G10D 13/02

(52) U.S. Cl. 84/411 R

(57) ABSTRACT

A new drum design with acoustic advantages. The design can also be used for use in drum kits that allow for closer spacing of the geometric centers between drums with a given area of drum head. This solution also provides for an increased tangential proximity between adjacent playing surfaces to reduce rim clicks. A further advantage is a large sweet spot for tone while still maintaining a wide range of tonal variation by playing in the corners.

### CROSS-REFERENCE TO RELATED APPLICATIONS

This application claims benefit of provisional application No. 60/744,647 filed Apr. 11, 2006.

### BACKGROUND OF THE INVENTION

1. Field of the Invention

The present invention relates to acoustic musical drums alone or assembled in a kit.

2. Description of the Related Art

Since ancient times man has played the drums for music, enjoyment, and as a form of expressive communication. Traditionally drums were made by hollowing logs and stretching a resonant playing surface called a head over the open portion which is stuck with a stick mallet or hand to make percussive music.

While there may be variations, modern drum shells can typically be described as tube segments which are typically comprised of a thin casing that is rigid and substantially cylindrical in shape. Attached to one or both ends of the shell is the head of the drum being a circular piece of thin plastic or animal hide stretched over the top or bottom of the cylinder respectively. The head of the drum is held in place by attaching it to a metal ring, or rim, then stretching the bead over the edge of the shell by a tensioning means. There are various means for tensioning the drum head. One may be in the form of attaching means which are uniformly spaced around the perimeter of the cylinder. The more tightly the head is stretched by the attaching means, the higher the pitch of the drum. This also has an effect on the tonal qualities or timbre of the drum.

Another factor related to the tonal qualities of the drum is the surface area of the head which is a function of the diameter of the cylinder. The number of individual preferences in drum pitch and sound may be as varied and individual as the number of drummers. Generally, however, many drummers these days appear to like the sound quality of tight grained shells made of maple or other tight grained wood. Acrylic and fiberglass re-enforced plastics may also be preferred where environmental such as temperature changes, or humidity conditions exist which swell and shrink drums of wooden construction.

Another factor for consideration in drum sound is the interaction of the design with the head of the drum. Until about the 1960's drum heads were made of animal skins, but have been replaced with a Mylar™ or other suitable sheet plastic material which can coated to dampen the resonance. Again this is defined by user preference.

A series of drums with different diameters and cylinder depths, in order to create a wide variation of tonal qualities, are then arranged near one another in such a way that the drummer can easily strike various combinations of drums to produce various sounds. This is typically referred to as a drum kit.

The art of playing a drum kit includes being able to move rapidly and rhythmically between the drums, or travel, striking each drum at or near the center of the drum to produce the best tonal qualities. This art requires a great deal of coordination and motor memory skills.

One particular problem encountered by the drummer when traveling between drums is a “click”, or striking between the drums heads on the rim without contact to the head. This makes a clicking sound that is generally avoided during regular playing sessions. The distance between and orientation of the drum heads is an important factor. The closer the drum heads are together the less likelihood of a click. Another factor in a click is related to the geometry of the drums being circular which allows for only a small tangential area between the drum heads.

Another problem is the amount of over-all movement necessary for the drummer when traveling from drum to drum. Generally, the less unnecessary movement required to play, the better. Therefore drums are usually situated relative to each other so that the heads are close together and the drum heads on roughly the same plane.

Various resonant sounds are made by the drum depending upon where the head is struck relative to the center. Typically close to the center creates a slightly lower tone with full timbre. Those near the edge create a higher tone with a more hollow timbre. The Experienced drummers often take advantage of these characteristics by spatially controlling the location and angle of striking the drum head.

Because the typical drum head is circular, therefore only direction available for spatially controlling the location is radially from the center.

### DESCRIPTION OF THIS INVENTION (ART)

A non cylindrical drum shell perimeter allows greater variation in the sound of the drum due to asymmetry as the drum is struck away from the center. This creates more variation between the bright and full timbre.

In addition, when several drums are situated together, this invention allows an arrangement whereby the center of each drum is closer together than if the full cylinder were used. This is best illustrated in FIG. 4. In this arrangement the typical drum cylinders have been replaced with polygons containing arcs and line segments. The line segments being situated on the tangential edges between drums. This moves the head diameters closer together by a distance of “d”, while maintaining the basic shape and tonal quality of the original cylinder.

The tenth edition of the Merriam Webster Collegiate Dictionary defines a polygon as 1) a closed plane figure bounded by straight lines, 2) a closed figure on a sphere bounded by arcs of great circles. Certainly by designing the shell perimeter using arcs of circles greater than that defined by the center-point of the perimeter, as would be done with a cylinder, allows for substantially elongated edges. As the radius of the great circle approaches infinity, the arc approaches a line. As the are approaches a line, the effective tangential area between the drum heads is maximized.

### SUMMARY

The principle object of this invention is to modify the shell of the drum from ordinary cylindrical shapes into alternate geometric shapes to create new tonal and timbre qualities. Another advantage is to reduce the distance between the geometric centers of the drum heads by arranging the substantially elongated sides adjacent to one another. Another advantage is to create a substantially tangential edge between the various drums to maximize the playing surface contact. This minimizes the travel space between adjacent drums.

### OBJECTS AND ADVANTAGES

It is an advantage of the present invention to create a substantially non-cylindrical drum shell.

It is a further advantage of the present invention to create unique shapes for drum shells from polygons made of line segments.

It is a further advantage of the present invention to create unique shapes for drum shells from polygons made of arcs.

It is a further advantage of the present invention to create unique shapes for drum shells from a combination of polygons and arcs.

It is a further advantage of the present invention to create a drum of tonal variation across the drumhead which is larger than that created by cylindrical drums.

It is a further advantage of the present invention to create an arrangement of drums created from polygons.

It is a further advantage of the present invention to create an arrangement of drums with a mean distance between drum geometric centers which is less than found with cylindrical drums.

It is a further advantage of the present invention to create an arrangement of drums with an elongated tangential edge between drums.

The foregoing has outlined rather broadly the features and technical advantages of this invention so that those skilled in the art may better understand the detailed description that follows.

Those skilled in the art will appreciate that they may readily use the conception and the specific embodiments disclosed as a basis for modifying or designing other structures for carrying out the same purposes of the present invention. Those skilled in the art will also realize that such equivalent constructions do not depart from the spirit and scope of the invention in its broadest form.

### DRAWING FIGURES

FIG. 1 shows an exploded view of a drum of one embodiment of the current invention.

FIG. 2 shows a perspective view of an arrangement of drums using one embodiment of the current invention.

FIG. 3 shows a top down view of the arrangement shown in FIG. 2.

FIG. 4 shows a top down view of an alternate embodiment of the current invention.

FIG. 5 shows a top down view of a second alternate embodiment of the current invention.

FIG. 6 shows a top down view of a third alternate embodiment of the current invention.

FIG. 7 shows a top down view of a forth alternate embodiment of the current invention.

FIG. 8 shows a top down view of an embodiment similar to that shown in FIG. 3, wherein the arrangement is suited to marching drums.

FIG. 9 shows a top down view of an embodiment similar to that shown in FIG. 5 wherein the arrangement is suited to marching drums.

FIG. 10 a, and b show a perspective and top schematic view of a snare drum of the first embodiment of this invention.

### DESCRIPTION—FIGS PREFERRED EMBODIMENT

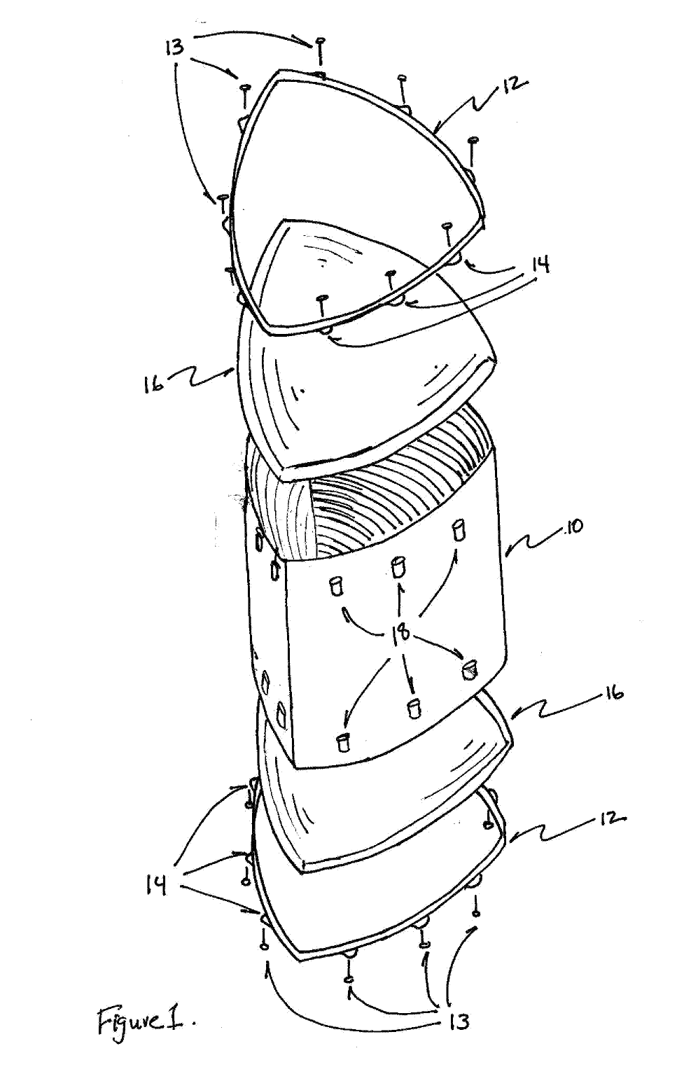

FIGS. 1, 2, 3, 8, and 10 are directed to a preferred embodiment of the invention. FIG. 1 is an exploded view of a typical tri-chordal drum design. The drum shell 10, which delineates the body of the drum, can be seen as a defined as an orthogonal or lateral projection from the shape as cast by the perimeter of the shell. A drum head 16, of similar same shape to the shell perimeter, but larger, can be mounted on the top opening forming a striking surface, and over the bottom opening as desired for tonal definition. Drum heads 16 are held in place using rims 12, attaching means 13, and rim anchoring means 14, the use of which should be familiar to one skilled in the art of drum making.

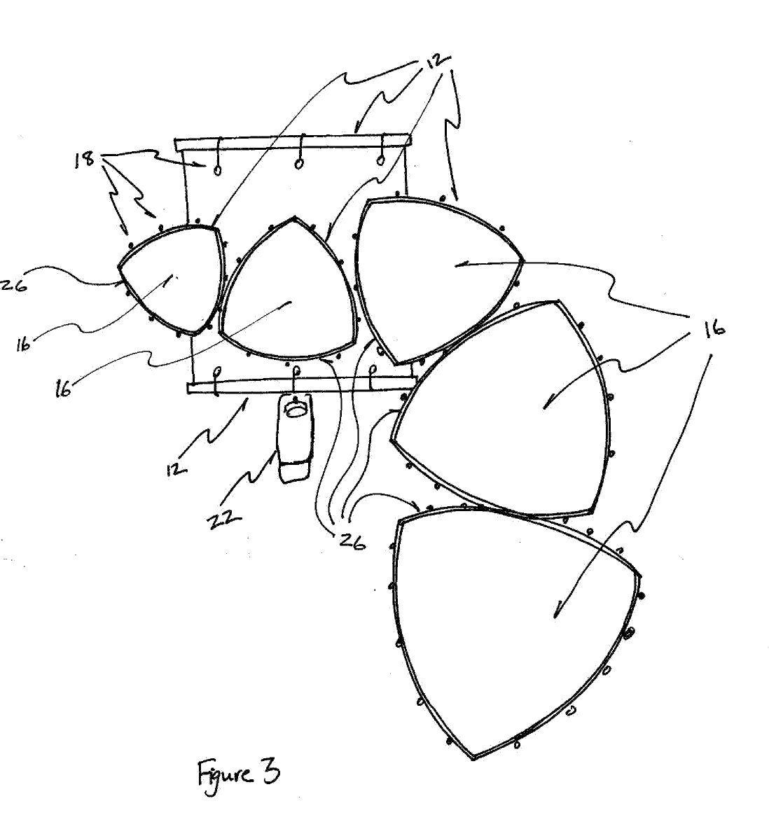

The term tri-chordal defines the basic perimeter shape, as shown in FIG. 3, being a form of convex triangle. This shape can be made by forming an equilateral triangle, each side of the triangle forming a chord segment who's radius is equal to the length of the triangle's side.

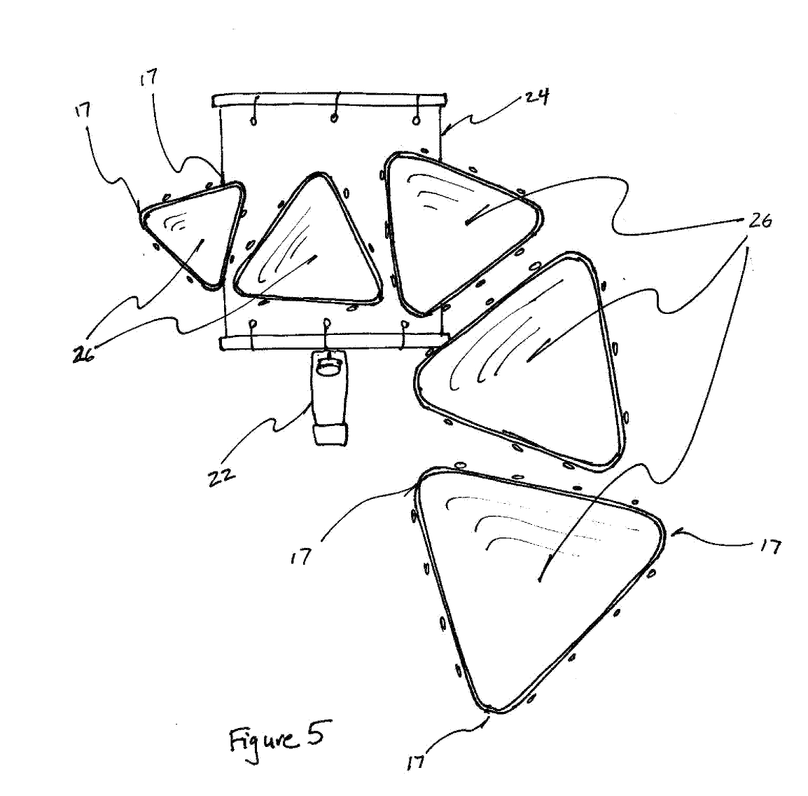

For manufacturability and resilience, it is recommended to use radius corners 17 shown in FIG. 5 to decrease any point stresses.

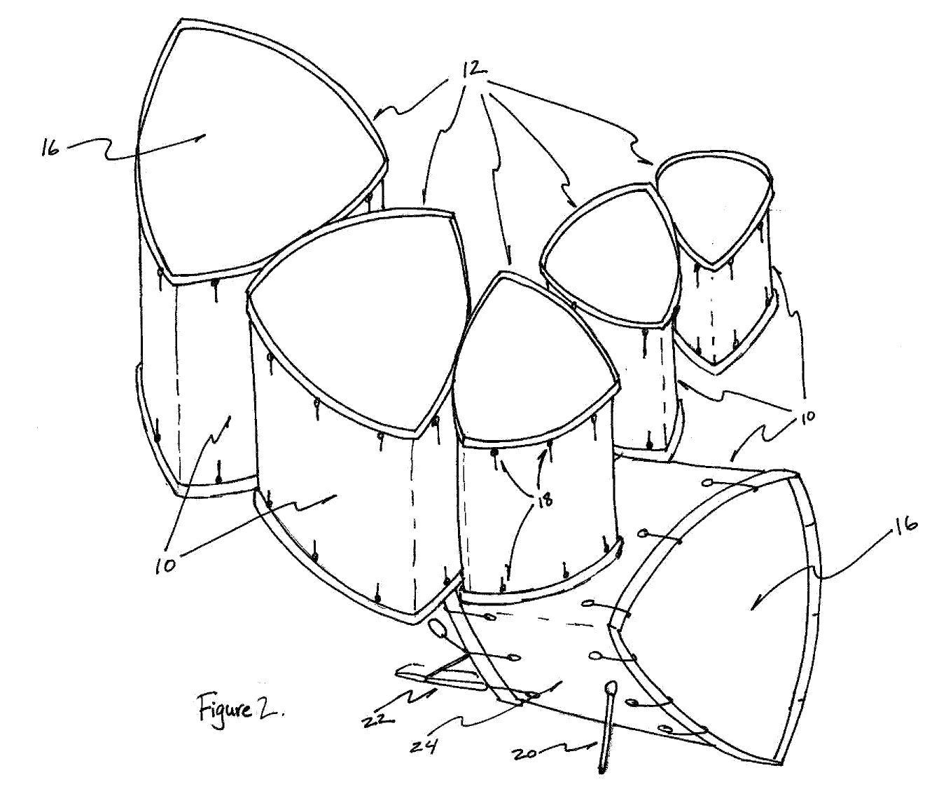

Once the individual drums are manufactured, they can be arranged as kits as shown in FIGS. 2, 3, and 8. The advantage of these arrangements over ordinary cylindrical drum shell based drums should be appreciated by one skilled in the art. Besides looking just plain “hot”, the tri-chordal drum can be arranged in a nested configuration which alternates top to bottom the base of one substantially triangular drum with the corner of the adjacent drum.

FIG. 2 depicts a kit with a large bass drum 24 forming a foundation piece with a foot peddle 22 removably attached to accommodate the playing thereof. The orientation of the bass drum 24 is generally with the shell 10 sideways and the drum head 16 perpendicular to the floor. Other drums, such as tom tom drums 26, snare drums 28, and other drums are kit up with the drum head 16 substantially parallel to the floor, with the fine points of orientation kit at the player's preference.

It is anticipated that, for a five tom tom drum 26 for example, a nested orientation as depicted in FIG. 3 would be optimum. In this orientation, moving clockwise from the left, it can be seen that the third and forth tom tom drums 26 are both arranged with the corners facing inward. This creates a substantially right angled turn which facilitates the drums wrapping around the player for ease of reaching the drum.

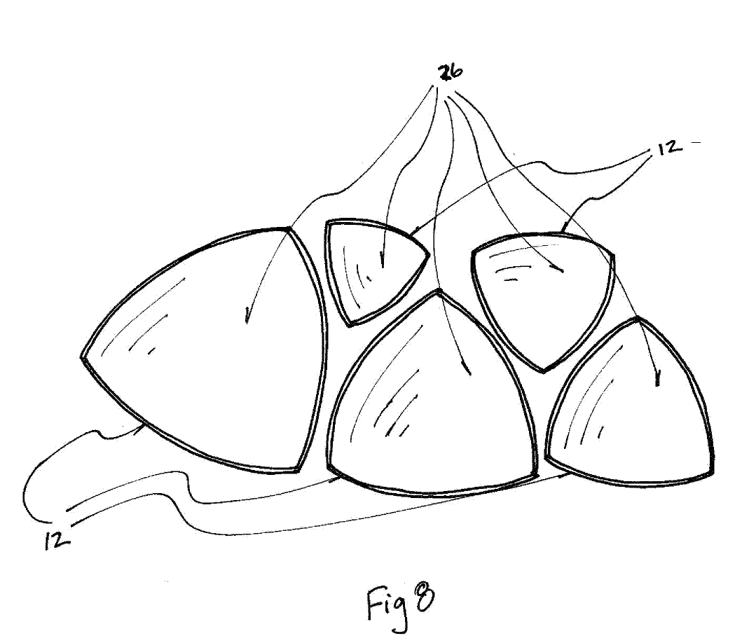

FIG. 8 depicts a kit arrangement, for marching bands and the like, where the tom tom drums 26 may be mounted on stands and carried onto a field. As can be seen, the drums nest very nicely together between the larger and smaller drums.

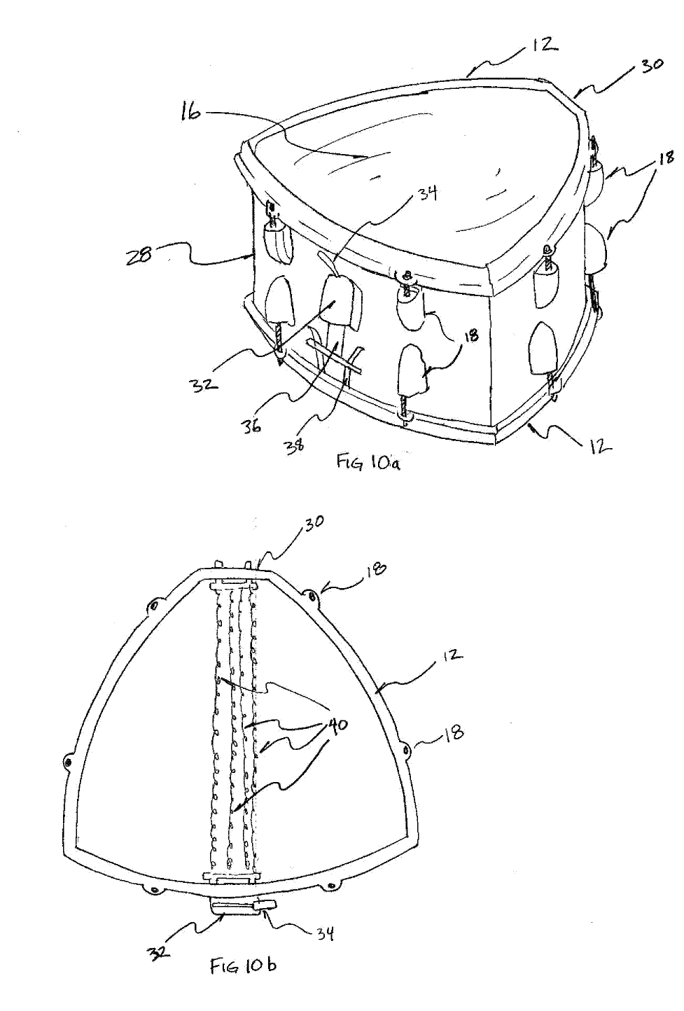

FIG. 10a and 10b depicts one embodiment for a snare drum 28. The snare drum 28 being similar to a tom tom drum 26 while comprising the additional elements of a gut 40 which can be made of coiled wire, animal “gut” or other suitable material which contacts a drum head 16 and makes a muffled rattling sound as the drum head vibrates. As the snare drum 28 generally requires the gut 40 to stretch across the middle of the drum, a chamfer 30 is added to the terminating end of the gut 40 to accommodate the mounting of the gut. Of coarse it is anticipated that in an alternate design that any or all corners may be chamfered as preferred by the user.

### DESCRIPTION—FIGS ADDITIONAL EMBODIMENTS

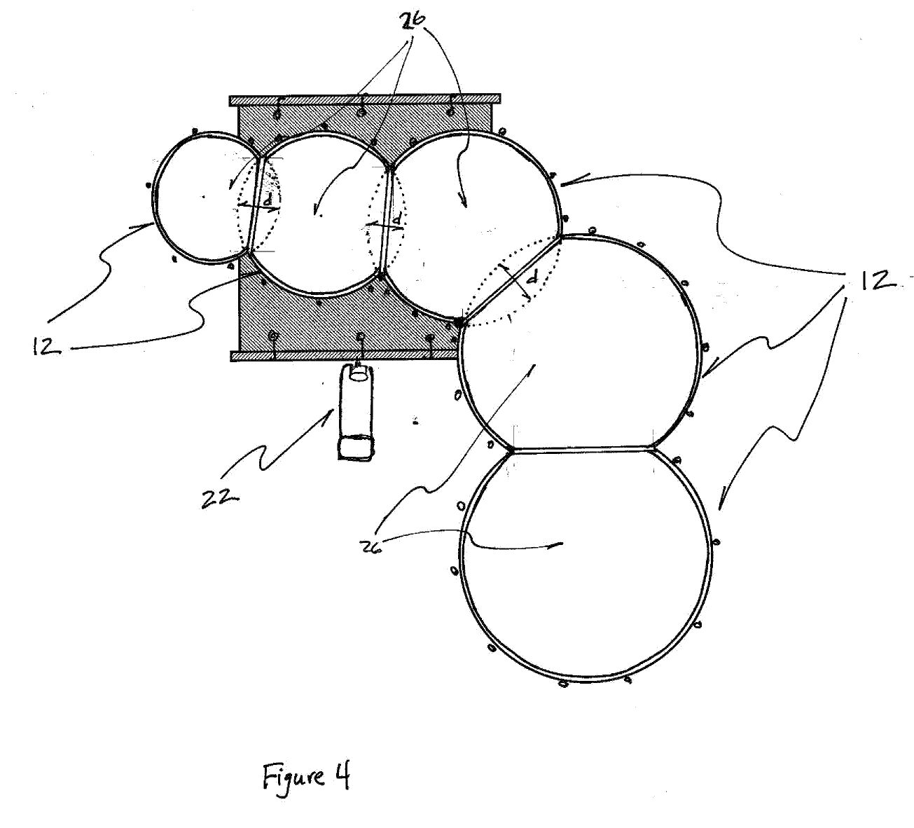

FIGS. 4, 5, 6, 7 and 9 illustrate alternate embodiments of the present invention.

FIG. 4 depicts a drum kit with an arrangement of tom tom drums 26 comprised of polygons which are made up of arcs and line segments. These drums are made following the methodology called out in the preferred embodiment.

FIG. 5 depicts a drum kit with an arrangement of tom tom drums 26 comprised of three sided polygons which are made up of substantially straight sides with arcs, or radiused, corners.

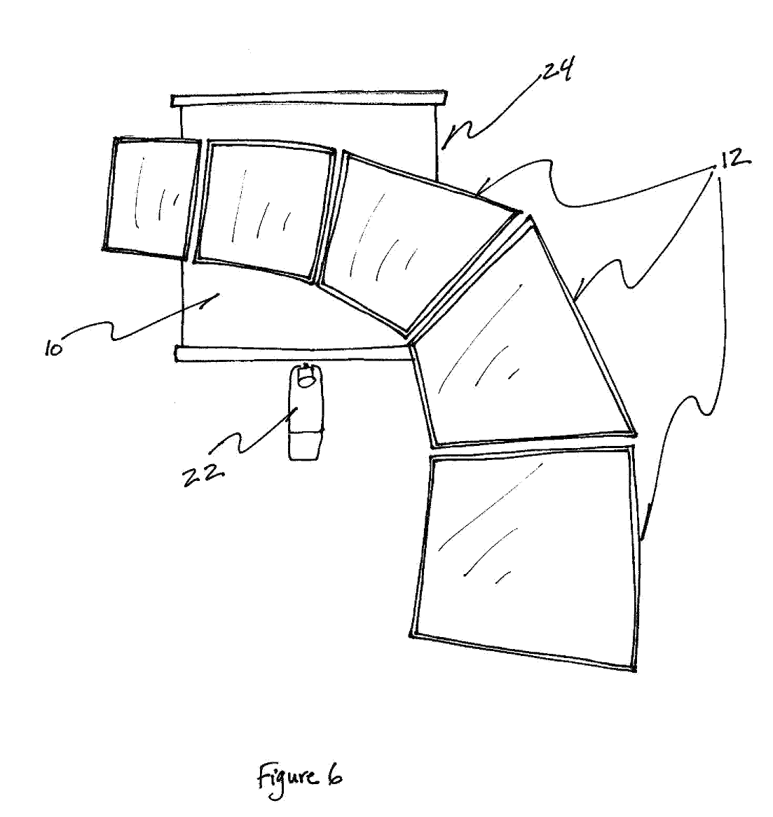

FIG. 6 depicts a drum kit with an arrangement of tom tom drums 26 comprised of four sided polygons with substantially straight edges with many of the edges being non parallel and forming shapes such as; trapezoids, parallelograms, and the like.

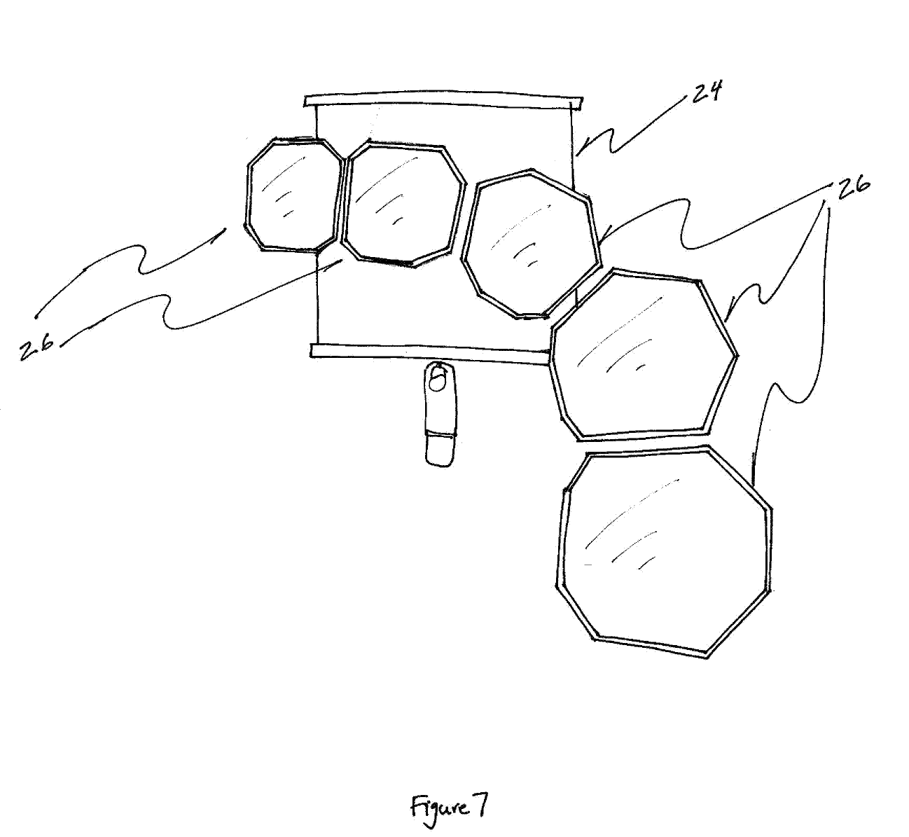

FIG. 7 depicts a drum kit with an arrangement of tom tom drums 26 comprised of n-sided polygons of irregular shape conforming to fill the space and maximize the tangential space between adjacent drums.

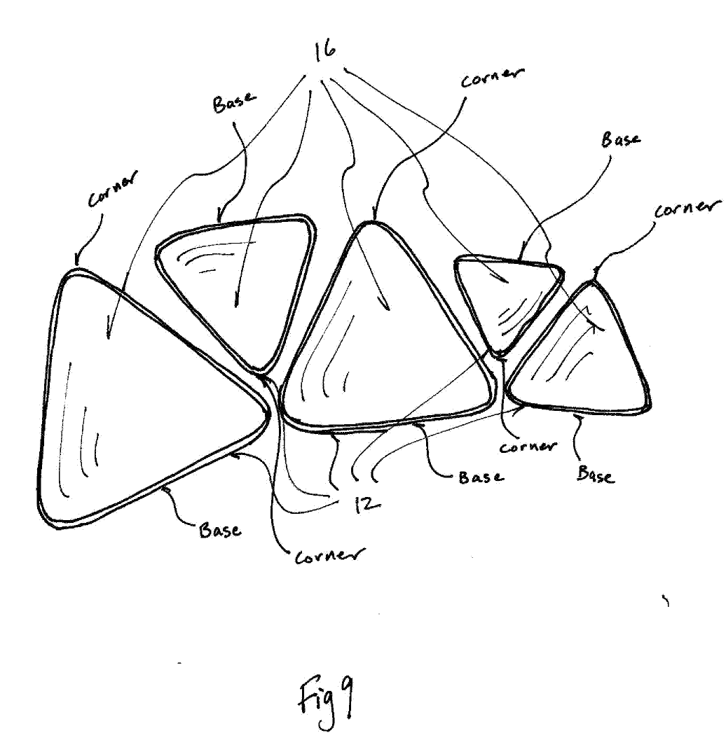

FIG. 9 depicts a drum kit arrangement of the drum of the present invention as shown in FIG. 5 arranged in a marching arrangement.

### CONCLUSION, RAMIFICATIONS, AND SCOPE

Thus the reader will see that the non-cylindrical perimeter design provides greater tonal variation on a single drum and advantages when traveling between drums when grouped together.

While the above description contains many specificities including the disclosure of a preferred embodiment designed to satisfy best mode requirements of 35 U.S.C. 112 paragraph 1. These should not be construed as limitations on the scope of the invention, but rather as an exemplification of one preferred embodiment with several additional modes designed to better teach the broader concept thereof. Many other variations are possible. For example various polygonal elements can be mixed or combined to form new arrangements. Polygons or combinations of polygons and arcs.

Accordingly, the scope of the invention should be determined not by the embodiment(s) illustrated, but by the appended claims and their legal equivalents.

We claim:

1. An instrument for acoustic drumming comprising:
(a) a shell which has a substantially non-circular perimeter;
(b) said shell extending laterally from said perimeter between a first open end and a second open end;
(c) the perimeter of said first and second open ends substantially laying on two separate planes, said planes being substantially parallel;
(d) means for stretching a drum head across first open end;
(e) means for tensioning said drum head.

2. An apparatus as defined in claim 1 comprising a shell which includes a lateral area being substantially non-cylindrical.

3. An apparatus as defined in claim 1 comprising a shell which includes a perimeter made of segments which are substantially linear in shape.

4. An apparatus as defined in claim 1, wherein said perimeter has a shape selected from the group of polygons.

5. An apparatus for drumming as defined in claim 4, comprising a shell comprising a polygon with adjoining sections which are convex in shape.

6. An apparatus for drumming as defined in claim 4, comprising a shell which includes a perimeter which is selected from the group of convex triangles.

7. An apparatus for drumming as defined in claim 4, comprising a shell which includes a perimeter which is selected from the group of rectangles

8. A kit for drumming comprising a plurality of drums each drum comprising:
(a) a shell which has a substantially non-circular perimeter;
(b) said shell extending laterally from said perimeter between a first open end and a second open end;
(c) the perimeter of said first and second open ends substantially laying on two separate planes, said planes being substantially parallel;
(d) means for stretching a drum head across first open end;
(e) means for tensioning said drum head.

9. A kit for drumming as defined in claim 8 comprising a plurality of drums wherein said each drum has a shape selected from the group of polygons.

10. A kit for drumming as defined in claim 8 comprising a plurality of drums arranged to reduce the distance between the geometric centers of each said drum head by arranging the substantially elongated sides of each said polygon adjacent to one another.

11. A kit for drumming as defined in claim 9 wherein said each drum has a shape selected from the group of convex triangles.

12. A kit for drumming as defined in claim 11 comprising a plurality of drums; wherein said drums are arranged in a nested configuration.

13. A method of designing an acoustic drum comprising:
(a) modifying the circular perimeter of the drum shell to include substantially straight portions
(b) modifying the circular perimeter of the drum rim to include substantially straight portions corresponding to the substantially straight portions found in the shell
(c) modifying the circular perimeter of the drum head to include substantially straight portions corresponding to the substantially straight portions found in the shell
(d) attaching the drum shell, drum rim, and drum head using attaching and anchoring means to form a drum.

14. A method of designing an acoustic drum in claim 13 where-in said substantially straight portion include large arcs.

15. A method of designing an acoustic drum in claim 13 where-in said substantially straight portion include line segments.

16. A method of designing an acoustic drum in claim 13 where-in said substantially straight portions form a polygon.

17. A method of producing a kit for drumming having reduced distance between geometric centers of the drum heads comprising;
(a) means for obtaining a plurality of drums
(b) each said drum having at least one substantially tangential edge
(c) arranging said substantially tangential edges adjacent to one another.

18. The method as defined in claim 17 further comprising arranging said drums in a nested configuration.
